(19) United States
(12) Patent Application Publication
(10) Pub. No.: US 2020/0264529 A1
(43) Pub. Date: Aug. 20, 2020

(54) ELECTROSTATIC IMAGE DEVELOPING TONER AND IMAGE FORMING METHOD

(71) Applicant: Konica Minolta, Inc., Tokyo (JP)

(72) Inventors: Seijiro TAKAHASHI, Tokyo (JP); Kouji SUGAMA, Tokyo (JP); Haruo HORIGUCHI, Tokyo (JP); Yukiko KUSANO, Toyohashi-shi (JP); Toyoko SHIBATA, Tokyo (JP)

(21) Appl. No.: 16/744,357

(22) Filed: Jan. 16, 2020

(30) Foreign Application Priority Data
Feb. 19, 2019 (JP) 2019-027040

(51) Int. Cl. G03G 9/087

(52) U.S. Cl. CPC G03G 9/08795; G03G 9/08797

(57) ABSTRACT

Provided is an electrostatic image developing toner including toner particles containing a light phase transition material that change from a solid state to a liquid state by light irradiation and a binder resin, wherein ΔH1 (J/g) is 0.1 or more, provided that ΔH1 (J/g) is an endothermic amount based on a melting peak derived from the light phase transition material in a first temperature raising process of raising a temperature from 25 to 200° C., the endothermic amount being obtained from a DSC curve measured by differential scanning calorimtry to the electrostatic image developing toner.

### CROSS-REFERENCE TO RELATED APPLICATIONS

The entire disclosure of Japanese Patent Application No. 2019-027040 filed on Feb. 19, 2019 is incorporated herein by reference in its entirety.

### BACKGROUND

### 1. Technological Field

The present invention relates to an electrostatic image developing toner and an image forming method. More particularly, the present invention relates to an electrostatic image developing toner and an image forming method capable of forming a toner image having high image strength in a fixing method by light irradiation.

### 2. Description of the Related Art

In the past, it was known an electrophotographic image forming apparatus for forming an image. In this method, an electrostatic latent image formed on a photoreceptor is developed with a toner to form a toner image, the formed toner image is transferred to a sheet, and the transferred toner image is heated and fixed, and an image is formed on the sheet. In such an image forming apparatus, in order to fix a toner image on a sheet by heat fixing, it is necessary to heat the toner to a high temperature and melt it once. For this reason, there is a limit to energy saving.

In recent years, systems have been proposed for fixing with an external stimulus different from heat in order to save energy during image formation, improve operability, and expand compatible media types. Among them, an optical fixing system that is relatively easily adapted to an electrophotographic process has attracted attention, and a developer (light-melting toner) that is softened by light has been reported.

For example, Patent Document 1 (JP-A 2014-191078) discloses a developer containing a binder resin, a colorant, and a compound that undergoes a cis-trans isomerization reaction by light absorption and undergoes phase transition as an additive. In Patent Document 1, as a fixing method using such a developer, there is disclosed a technique in which a toner image transferred to a sheet is irradiated with light, the compound undergoing phase transition by light absorption is melted, and then irradiated again to solidify the compound, thereby the toner image is fixed on a sheet.

Patent Document 2 (JP-A 2014-191077) discloses an image forming apparatus in which a developer containing a compound that undergoes a cis-trans isomerization reaction and undergoes phase transition by light absorption is used. As an example of such an image forming apparatus, it is proposed the following image forming apparatus. An image forming apparatus having an exposure device that irradiates light toward a nip position where a conveyance belt is sandwiched between a photosensitive member and a transfer roller when an image is formed on a recording sheet made of a transparent resin has been proposed.

However, the developers described in Patent Document 1 and Patent Document 2 are both low productivity because the softening speed by light irradiation is not sufficient, and have the problem that the image strength of the formed toner image is low.

On the other hand, as a method for improving the softening speed by light irradiation and the fixability of a toner image, a light-melting toner containing an azobenzene derivative as a light phase transition material is disclosed, for example, in Patent Document 3 (JP-A 2018-005049) and Patent Document 4 (JP-A 2018-124387). In these proposed methods, the toner image quality is improved to some extent as compared with the conventional methods, but the viscosity reduction of the toner image due to light irradiation is insufficient and the image strength is slightly low.

Further, in each of the disclosed patent documents, there is no mention of a method for defining a relationship based on the thermal characteristics between the light phase transition material and the binder resin. Since the light phase transition material in the conventionally proposed method exists in a molecularly dispersed state in the binder resin, the effect of softening due to the change in the molecular state is small even when light irradiation is performed, and the image strength is reduced. It is thought that the image strength has not been improved.

Therefore, development of an electrostatic image developing toner and an image forming method capable of improving image strength in a fixing system using light irradiation is desired.

### SUMMARY

The present invention has been made in view of the above problems and situations, and an object of the present invention is to provide an electrostatic image developing toner and an image forming method capable of forming a toner image having high image strength in a fixing method by light irradiation.

To achieve at least one of the above-mentioned objects according to the present invention, an electrostatic image developing toner that reflects an aspect of the present invention comprises toner particles containing a light phase transition material that change from a solid state to a liquid state by light irradiation and a binder resin, wherein ΔH1 (J/g) satisfies a condition defined by the following relational expression (1), provided that ΔH1 (J/g) is an endothermic amount based on a melting peak derived from the light phase transition material in a first temperature raising process of raising the temperature from 25° C. to 200° C., the endothermic amount being obtained from a DSC curve measured by differential scanning calorimetry to the electrostatic image developing toner.

0.1≤ΔH1 Relational expression (1):

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic configuration diagram illustrating an example of a configuration of an image forming apparatus applicable to an image forming method.

FIG. 2 is a schematic configuration diagram illustrating an example of the configuration of the light irradiation unit constituting the image forming apparatus.

### DETAILED DESCRIPTION OF THE EMBODIMENTS

Hereinafter, one or more embodiments of the present invention will be described. However, the scope of the invention is not limited to the disclosed embodiments.

The electrostatic image developing toner of the present invention contains at least a light phase transition material that changes from a solid state to a liquid state by light irradiation and a binder resin. An endothermic amount ΔH1 (J/g) based on a melting peak derived from the light phase transition material in a first temperature rising process from 25° C. to 200° C. obtained from a DSC curve measured by scanning calorimetry satisfies the above-described relational expression (1). This feature is a technical feature common to or corresponding to each of the following embodiments.

According to the present invention, it is possible to provide an electrostatic charge image developing toner and an image forming method capable of obtaining a toner image having excellent image strength in a fixing method by light irradiation.

The expression mechanism or action mechanism of the effect of the transfer body having the structure defined in the present invention is not clear, but it is presumed as follows.

As a representative light phase transition material that absorbs light and softens from a solid state (light phase transition), an azobenzene compound may be cited. The light phase transition of the azobenzene compound is considered to be caused by the collapse of the crystal structure due to cis-trans isomerization. However, since azobenzene compounds are highly compatible with binder resins such as styrene-acrylic resins and polyester resins, it is found that they often do not have a crystal structure in toners for developing electrostatic images (hereinafter also simply referred to as toners). When the azobenzene compound does not have a sufficient crystal structure, the crystal structure will not be destroyed by light irradiation, resulting in a problem that the decrease in melt viscosity due to cis-trans isomerization is small and the fixing strength is not sufficiently increased.

In the toner of the present invention, an endothermic amount ΔH1 (J/g) based on a melting peak derived from the light phase transition material in a first temperature rising process from 25° C. to 200° C. obtained from a DSC curve measured by differential scanning calorimetry is 0.1 or more.

The toner having a melting peak derived from the light phase transition material of the present invention is considered to have a crystal region of the light phase transition material in the toner. In the crystal region, a phase transition is effectively generated during light irradiation Therefore, it is considered that the binder resin around the light phase transition material is compatible with each other, so that softening as toner particles is promoted and fixing strength is secured.

Since the phase transition of the light phase transition material is induced by a change in the molecular structure of the crystalline region, it was found that it is important from the viewpoint of softening the toner particles to exist in a crystalline state rather than being dispersed as a single molecule in the binder resin.

It is presumed that in the state where the light phase transition material is dispersed in a single molecule in the binder resin, the softening effect accompanying the change in the molecular structure only slightly changes the interaction of the peripheral binder resin.

Therefore, an excellent image strength may be obtained by using a toner containing a light phase transition material having such characteristics.

As an embodiment of the present invention, from the viewpoint that the effects of the present invention may be more manifested, ΔH1 (J/g) and ΔH2 (J/g) satisfy the condition defined by the relational expression (2), wherein ΔH2 (J/g) is a second endothermic amount based on a melting peak derived from the light phase transition material in a second temperature rising process of raising a temperature from 25° C. to 200° C. following the measurement of the first endothermic amount ΔH1 (J/g). Satisfying the condition defined by the relational expression (2) is preferable since the phase change material is more effectively phase-shifted, so that it is compatible with the surrounding binder resin, the light softening effect is promoted, and the image strength is excellent.

ΔH1<ΔH2 Relational expression (2):

Further, the ratio of the endothermic amounts ΔH1 (J/g) and ΔH2 (J/g) (=(ΔH2/ΔH1)×100) is preferably in the range of 0 to 80 (Relational expression (3)) from the viewpoint of particularly promoting the light softening effect of the toner.

0≤(ΔH2/ΔH1)×100≤80 Relational expression (3):

Further, the number average molecular weight Mn of the light phase transition material is required to be within the range of 150 to 2900 in order to use the binder resin together. It is considered necessary for obtaining good image strength that the light phase transition material has a high fluidity in the liquid state. When the number average molecular weight Mn exceeds 2900, the fluidity for obtaining good image strength is insufficient, and when it is less than 150, the light phase transition phenomenon will not occur.

Further, when the melting point of the light phase transition material is Tm (° C.) and the softening point temperature of the binder resin is Tsp (° C.), it is preferable that the relational expression (4) is satisfied. If the elation (4) is satisfied, ΔH1 derived from the crystal region of the light phase transition material is increased, and the light softening effect may be maximized Moreover, if it falls outside the range of the relational expression (4), it becomes difficult to sufficiently obtain the object effect of the present invention.

Tm≥Tsp −20 Relational expression (4):

The melting point Tm of the light phase transition material is preferably in the range of 40 to 120° C. from the viewpoint of improving the output image strength at room temperature and the toner storage property. Further, the melting point Tm of the light phase transition material is preferably 120° C. or less from the viewpoint that an image may be formed without requiring excessive energy.

Also, when an amorphous binder resin is used as a binder resin, there is produced no clear endothermic peak in the temperature range of the endothermic peak due to the light phase transition material, which is preferable in that the melting peak derived from the light phase transition material may be accurately extracted.

Further, the image forming method of the present invention contains: a step of forming a toner image comprising the electrostatic image developing toner of the present invention on a recording medium; and a step of irradiating the toner image with light to soften the toner image. Furthermore, it is preferable that the wavelength of light applied to the toner image is not less than 280 nm and less than 480 nm from the viewpoint that the phase transition can be performed efficiently.

The present invention and the constitution elements thereof, as well as configurations and embodiments, will be detailed in the following. In the present description, when two figures are used to indicate a range of value before and after “to”, these figures are included in the range as a lowest limit value and an upper limit value.

### <<Electrostatic Image Developing Toner>>

The electrostatic image developing toner of the present invention contains at least a light phase transition material that changes from a solid state to a liquid state by light irradiation and a binder resin. The endothermic amount ΔH1 (J/g) based on the melting peak derived from the light phase transition material in the first temperature rising process from 25° C. to 200° C. obtained from the DSC curve measured by scanning calorimetry is 0.1 or more.

### [DSC Measurement by Differential Scanning Calorimetry]

The endothermic amount ΔH1 (J/g) based on the melting peak derived from the light phase transition material in the first temperature rising process from 25° C. to 200° C., which is obtained from the DSC curve by differential scanning calorimetry in the electrostatic charge developing toner of the present invention is 0.1 or more. Further, following the measurement of the first endothermic amount ΔH1 (J/g), when the endothermic amount ΔH2 (J/g) based on the melting peak derived from the light phase transition material in the second temperature raising process in which the temperature is raised from 0° C. to 200° C. is measured, it is preferable that the second endothermic amount ΔH2 is smaller than the first endothermic amount AHL Further, it is a preferable aspect that the value of (ΔH2/H1)×100 is 0 or more and 80 or less.

First, the differential scanning calorimetry method will be described.

For example, a high-sensitivity differential scanning calorimeter “DSC7000X” (Hitachi High-Tech Science Co., Ltd.) is used for the differential scanning calorimetry of the toner. The temperature is raised from 25° C. to 200° C. at an elevation rate of 10° C./min, and the endothermic amount ΔH1 (J/g) based on the melting peak derived from the light phase transition material is measured from the obtained DSC curve. The endothermic amount ΔH1 (J/g) of the toner of the present invention measured under these conditions is 0.1 or more.

Next, after isothermal holding at 200° C. for 5 minutes, cooling is performed from 200° C. to 0° C. at a cooling rate of 10° C./min, and the isothermal holding is performed at 0° C. for 5 minutes. In the second temperature raising process in which the temperature is raised to 200° C., the endothermic amount ΔH2 (J/g) based on the melting peak derived from the light phase transition material is measured.

As a measurement procedure, 3.0 mg of toner is sealed in an aluminum pan and set in a sample holder of the above “DSC7000X”. An empty aluminum pan was used as a reference.

Since the toner of the present invention contains a light phase transition material, the DSC curve obtained by differential scanning calorimetry of the toner has an endothermic peak (melting peak) derived from the light phase transition material.

The compatibility state of the light phase transition material and the binder resin in the toner particles is determined from the endothermic amount based on the melting peak derived from the light phase transition material in the DSC curve obtained by differential scanning calorimetry.

That is, ΔH2/ΔH1 according to the relational expression (3), which is the ratio of ΔH2 and ΔH1, represents a change in the crystallization ratio of the light phase transition material before and after the fixing step. A smaller ΔH2/ΔH1 means that the compatibility of the light phase transition material is promoted in the fixing step.

In the DSC curve obtained by the above differential scanning calorimetry, when the melting peak related to ΔH1 is obtained as an overlapping peak having two or more peak tops overlapping with peaks derived from other toner constituent materials, first, an endothermic amount ΔH (J/g) from the start point to the end point of the overlapping peak with respect to the baseline is obtained. Then, the partial area ratio Si (%) of the melting peak derived from the light phase transition material when the peak area of this overlapping peak is set to be 100% is obtained, and ΔH1 (J/g) is obtained by ΔH (J/g)×Si (%). The partial area ratio Si of the melting peak derived from the light phase transition material in the overlapping peak is obtained as follows. First, the peak surface is divided by a perpendicular line extending from a minimum point between a plurality of peak tops in the overlapping peak to the temperature axis. In this overlapping peak, the peak having the peak top temperature closest to the melting point of the light phase transition material alone is taken as the melting peak derived from the light phase transition material, and this partial area ratio is obtained.

The same applies to the case where the melting peak related to ΔH2 has two or more peak tops.

When the toner contains a binder resin and other components and it is difficult to detect the minute endothermic amount ΔH1 (J/g) of the light phase transition material, a toner containing a light phase change material and other components and a reference toner sample that does not contain the light phase change material are produced. The endothermic amount ΔH1 (J/g) corresponding to the light phase transition material can be obtained from the difference in the measured DSC curves.

In the present invention, the endothermic amount ΔH1 (J/g) based on the melting peak derived from the light phase transition material is 0.1 or more. Depending on the characteristics of the compound, it is preferably in the range of 0.1 to 50 (J/g), more preferably in the range of 1.0 to 40 (J/g).

### [Light Phase Transition Material]

The electrostatic image developing toner of the present invention contains a light phase transition material that changes from a solid state to a liquid state by light irradiation. The light phase transition material has an endothermic amount ΔH1 (J/g) based on the melting peak derived from the light phase transition material in the first temperature rising process from 25° C. to 200° C. obtained from the DSC curve measured by differential scanning calorimetry is 0.1 or more.

Further, in a preferred embodiment, following the measurement of the first endothermic amount ΔH 1 (J/g), the endothermic amount ΔH2 (J/g) based on the melting peak derived from the light phase transition material in the second temperature raising process in which the temperature is raised from 0° C. to 200° C. is smaller than the first endothermic amount ΔH1 (J/g).

The light phase transition material according to the present invention is a compound that changes from a solid state to a liquid state by light irradiation, and an endothermic amount ΔH1 (J/g) based on a melting peak defined in the present invention is 0.1 or more. As long as the above condition is satisfied, there is no particular limitation, but a compound selected from the following compound group may be exemplified.
(1) A monocyclic compound or a heterocyclic compound having a diazo group (R—N═N—R′), and representative examples include azobenzene derivatives.
(2) A monocyclic compound or a heterocyclic compound having a vinylene group (R—C═C—R′), and representative examples include stilbene derivatives.
(3) A monocyclic compound or a heterocyclic compound having an azomethine group (R—C═N—R′), and representative examples include azomethine derivatives.

Among the above-mentioned light phase transition materials, an azobenzene derivative is preferable from the viewpoint of easily changing a toner image from a solid state to a liquid state even with a lower energy irradiation amount.

### (Azobenzene Derivative)

Hereinafter, details of an azobenzene derivative will be described as a typical light phase transition material.

Examples of the azobenzene derivative applicable to the present invention include azobenzene derivatives having a structure represented by the following Formula (1).

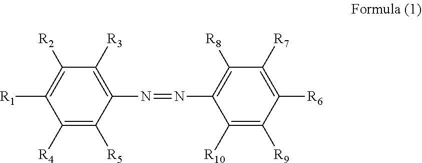

In Formula (1), R₁ to R₁₀ each independently represent a group selected from the group consisting of a hydrogen atom, an alkyl group, an alkoxy group, a halogen atom, a hydroxy group and a carboxy group. At least three of R₁ to R₁₀ represent a group selected from the group consisting of an alkyl group, an alkoxy group, a halogen atom, a hydroxy group and a carboxy group. At least one of R₁ to R₅ represents an alkyl group or an alkoxy group having 1 to 18 carbon atoms. And at least one of R₆ to R₁₀ represents an alkyl group or an alkoxy group having 1 to 18 carbon atoms.

Examples of the alkyl group include: straight-chain alkyl groups such as a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group; and branched alkyl groups such as an isopropyl group, an isobutyl group, a sec-butyl group, a tert-butyl group, an isoamyl group, a tert-pentyl group, a neopentyl group, a 1-methylpentyl group, a 4-methyl-2-pentyl group, a 3,3-dimethylbutyl group, a 2-ethylbutyl group, a 1-methylhexyl group, a tert-octyl group, a 1-methylheptyl group, a 2-ethylhexyl group, a 2-propylpentyl group, a 2,2-dimethylheptyl group, a 2,6-dimethyl-4-heptyl group, a 3,5,5-trimethylhexyl group, a 1-methyldecyl group, and a 1-hexylheptyl group.

Examples of the alkoxy group include: straight-chain alkoxy groups such as a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, and an n-hexadecyloxy group; and branched alkoxy groups such as an isopropoxy group, a tert-butoxy group, a 1-methylpentyloxy group, a 4-methyl-2-pentyloxy group, a 3,3-dimethylbutyloxy group, a 2-ethylbutyloxy group, a 1-methylhexyloxy group, a tert-octyloxy group, a 1-methylheptyloxy group, a 2-ethylhexyloxy group, a 2-propylpentyloxy group, a 2,2-dimethylheptyloxy group, a 2,6-dimethyl-4-heptyloxy group, a 3,5,5-trimethylhexyloxy group, a 1-methyldecyloxy group, and a 1-hexylheptyloxy group.

The halogen atom refers to a fluorine atom (—F), a chlorine atom (—Cl), a bromine atom (—Br) or an iodine atom (—I).

In Formula (1), R₁ and R₆ are preferably each independently an alkyl group or an alkoxy group having 1 to 18 carbon atoms. Among them, from the viewpoint of further improving the fixability of the image, R₁ and R6 are preferably each independently an alkoxy group having 1 to 18 carbon atoms. Thus, having an alkyl group or alkoxy group having 1 to 18 carbon atoms at the para position of two benzene rings increases the thermal mobility of the molecule. And as described above, it is likely that the overall melting o will occur in sequence throughout the system. Although an alkyl group or an alkoxy group having 1 to 18 carbon atoms represented by R₁ and R₆ may be straight-chain or branched, from the viewpoint of forming the structure of rod-like molecules in which light phase transition is likely to occur, the straight-chain is preferable.

In particular, R₁ and R₆ are preferably each independently an alkyl group or an alkoxy group having 6 to 12 carbon atoms. When R₁ and R₆ are an alkyl group or an alkoxy group within the above-mentioned carbon number range, the alkyl-alkyl interaction acting between molecules is relatively weak while having high thermal mobility. Therefore, cis-trans isomerization is more likely to proceed, and the melting rate by light irradiation and the image fixability are more improved.

R₁ and R₆ may be the same or different, but are preferably the same in terms of easiness of synthesis.

In Formula (1), at least one of R₂ to R₅ and R₇ to R₁₀ is a group selected from the group consisting of an alkyl group, an alkoxy group, a halogen group, a hydroxy group and a carboxy group (hereinafter referred to simply as “a substituent”). Having such a structure results in the formation of lattice defects that favor cis-trans isomerization, the appearance of free volume, and the reduction of π-π interactions. Therefore, cis-trans isomerization is more likely to proceed, and the melting or softening rate by light irradiation and the fixation of the image are further improved. In particular, from the viewpoint of securing a free volume necessary for cis-trans isomerization, at least one of R₂ to R₅ and R₇ to R₁₀ is preferably an alkyl or alkoxy group having 1 to 4 carbon atoms which may have a branch or a halogen group. From the viewpoint of further improving the fixability of the image, an alkyl group having 1 to 4 carbon atoms is more preferable, and a methyl group is particularly preferable.

In Formula (1), the number of substituents in R₂ to R₅ and R₇ to R₁₀ is preferably 1 to 8, and more preferably 1 to 6. In particular, from the viewpoint of not lowering the melting point of the azobenzene derivative too much and further improving the heat resistant storage stability of the toner, the number of substituents is more preferably 1 to 4, and particularly preferably 1 to 3.

The position at which a substituent is present in R₂ to R₅ and R₇ to R₁₀ is not particularly limited, preferably, at least a substituent is present in any of R₂, R₄, R₇ and R₉ (in other words, the ortho position of R₁ and the ortho position of R₆) of Formula (1). Further preferably, a methyl group is present in any one of R₂, R₄, R₇ and R₉ of Formula (1). The azobenzene derivative having such a structure further improves the fixing property of the image since the melting or softening rate by light irradiation is further improved, and the melting point is appropriately increased, so that the heat resistant storage stability of the toner is also improved.

Preferable azobenzene derivatives according to the present invention are compounds derived from 4,4′-dialkyl azobenzene and 4,4′-bis(alkoxy) azobenzene. Examples thereof are derivatives of 4,4′-dialkyl azobenzene having the same alkyl group of 1 to 18 carbon atoms as R₁ and R₆ in Formula (1) such as 4,4′-dihexylazobenzene, 4,4′-dioctylazobenzene, 4,4′-didecylazobenzene, 4,4′-didodecylazobenzene, and 4,4′-dihexadecylazobenzene. Another examples thereof are derivatives of 4,4′-bis(alkoxy)azobenzene having the same alkoxy group of 1 to 18 carbon atoms as R₁ and R₆ in Formula (1) such as 4,4′-bis(hexyloxy)azobenzene, 4,4′-bis(octyloxy)azobenzene, 4,4′-bis(dodecyloxy)azobenzene, and 4,4′-bis(hexadecyloxy) azobenzene. Preferable derivatives are compounds in which the hydrogen atom attached to the benzene ring is mono-, di- or tri-substituted by a group selected from the group consisting of alkyl group, alkoxy group, halogen group, hydroxy group and carboxy group. Specific examples of the azobenzene derivative are the following azobenzene derivatives (1) to (13). In the following azobenzene derivatives, the cis-trans state is not indicated.

### Azobenzene Derivatives

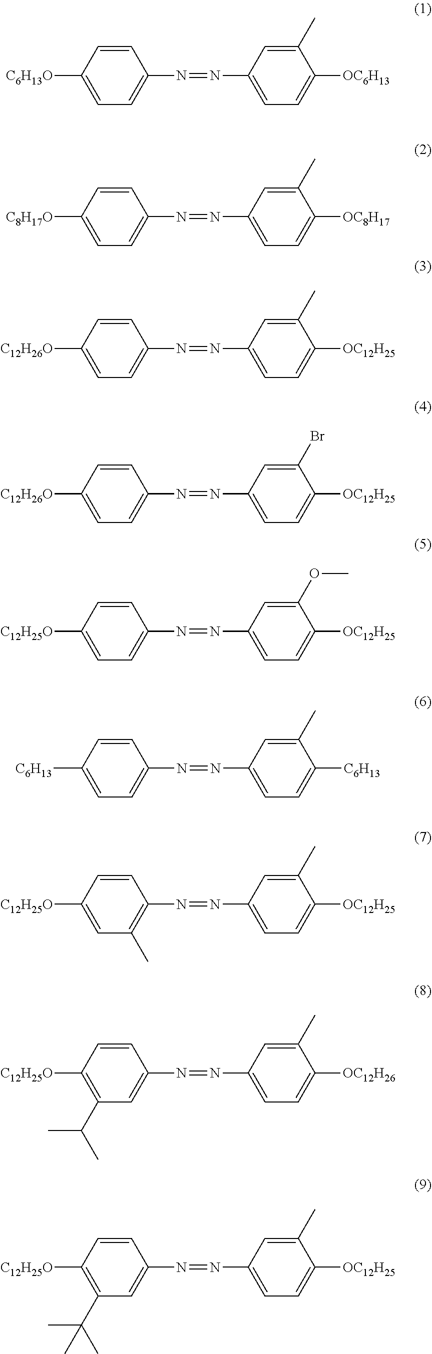

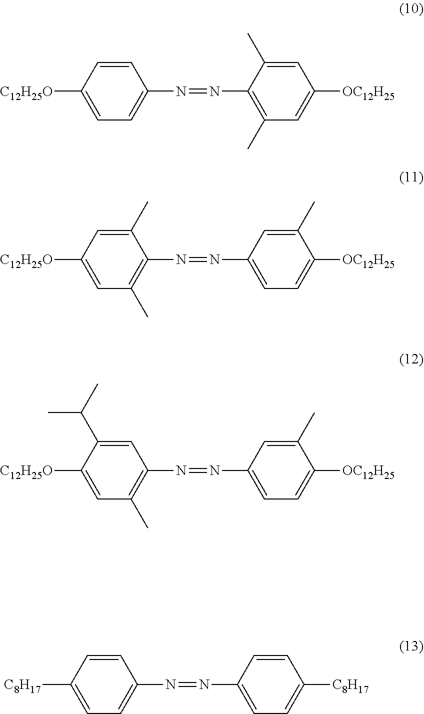

The synthetic method of the azobenzene derivative is not particularly limited, and conventionally known synthetic methods may be applied.

### SYNTHETIC EXAMPLE 1

Synthesis of Azobenzene Derivative (1)

For example, as in the following Reaction Scheme A, 4-aminophenol is reacted with sodium nitrite under cooling to form a diazonium salt. This is reacted with o-cresol to synthesize intermediate A (first step), and then n-bromohexane is allowed to react with the intermediate A (second step). Thus, the above azobenzene derivative (1) may be obtained.

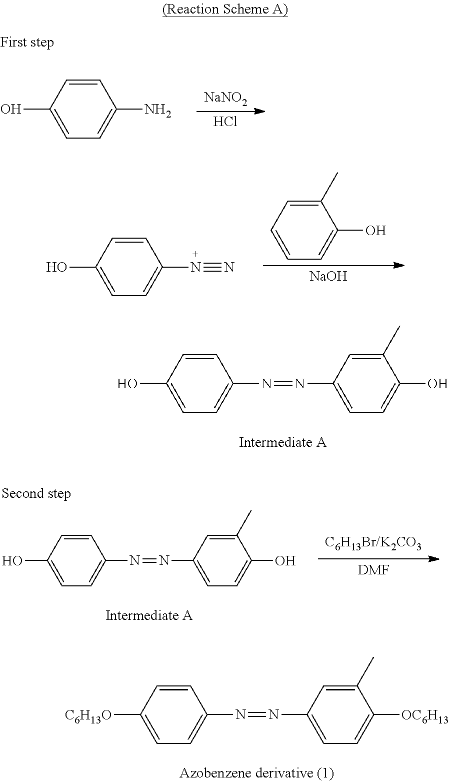

### SYNTHETIC EXAMPLE 2

Synthesis of Azobenzene Derivative (4)

As indicated in the following Reaction Scheme B, the azobenzene derivative (4) may be obtained by changing o-cresol and n-bromohexane to 2-bromophenol and n-bromododecane respectively.

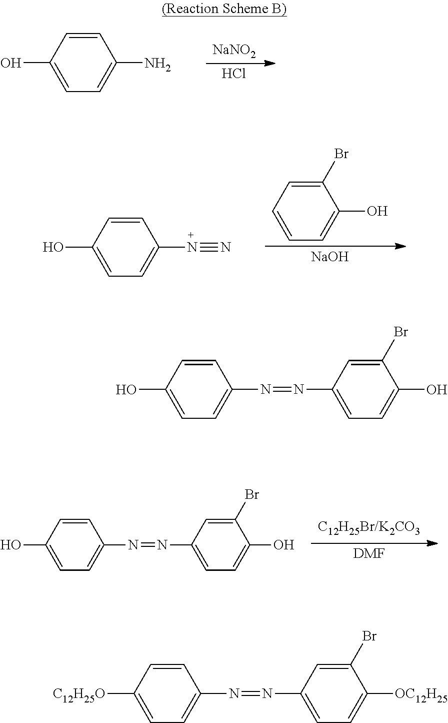

### SYNTHETIC EXAMPLE 3

Synthesis of Azobenzene Derivative (5)

As indicated in the following reaction formula C, an azobenzene derivative compound (5) may be obtained by reacting an azobenzene derivative compound (4) with methanol in the presence of a Pd catalyst and a base.

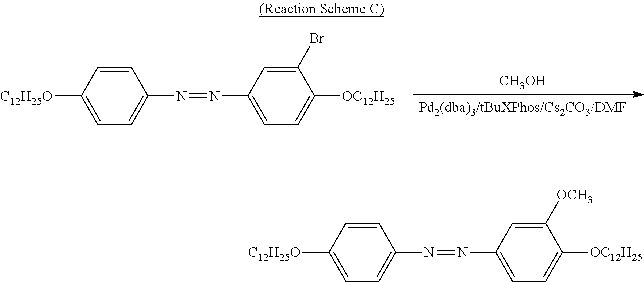

### SYNTHETIC EXAMPLE 4

Synthesis of Azobenzene Derivative (6)

As indicated in the following Reaction Scheme D, manganese dioxide as an oxidizing agent is reacted with p-hexylaniline to synthesize 4,4′-dihexylazobenzene and then reacted with N-bromosuccinimide. An azobenzene derivative (6) may be obtained by reacting methylboronic acid in the presence of a Pd catalyst and a base.

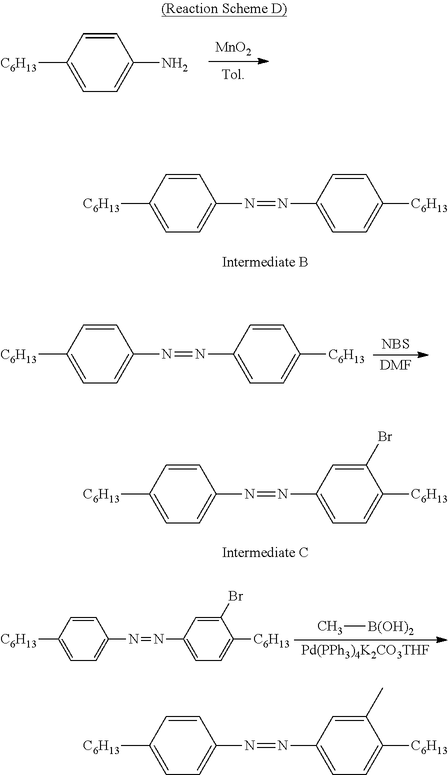

In the above Reaction Scheme D, the azobenzene derivative in which R₁ and R₆ in Formula (1) are alkyl groups is obtained by changing the starting material (p-hexylaniline and/or methylboronic acid) to another compound. A person skilled in the art can synthesize a desired azobenzene derivative by appropriately making the above changes.

These azobenzene derivatives may be used alone or in combination of two or more.

### (Azomethine Derivative)

Specific examples of the azomethine derivative applicable to the present invention include the following azomethine derivative (A).

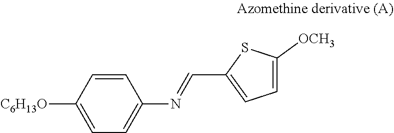

The method for synthesizing the azomethine derivative is not particularly limited, and a conventionally known synthetic method may be applied.

### SYNTHETIC EXAMPLE 5

Synthesis of Azomethine Derivative (A)

As indicated in the following Reaction Scheme E, the azomethine derivative (A) may be obtained according to the following schemes 1 to 3.

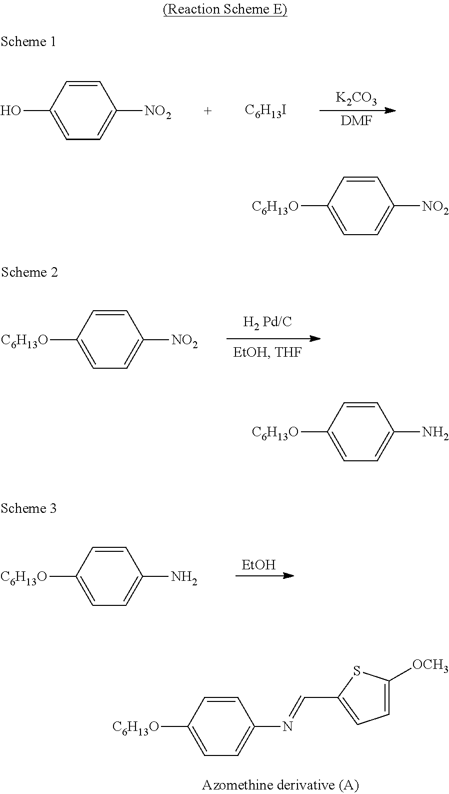

In the above Reaction Scheme E, raw materials 4-nitrophenol and 1-iodohexane (C₆H₁₃I) are reacted by heating under reflux using potassium carbonate (K₂CO₃) in dimethylformamide (DMF), and the reaction solution is washed with water. By concentrating and purifying, 4-hexyloxynitrobenzene can be obtained (see Scheme 1 above).

Next, in a mixed solvent of ethanol (EtOH) and tetrahydrofuran (THF), the reaction is performed while enclosing hydrogen gas (H₂) against 4-hexyloxynitrobenzene obtained in Scheme 1 under palladium on carbon (Pd/C catalyst) with stirring. 4-(Hexyloxy)aniline is obtained by removing the catalyst from the reaction solution, concentrating the solution, and recrystallizing with ethanol (see Scheme 2 above).

Subsequently, 4-(hexyloxy)aniline obtained in Scheme 2 and 5-methoxythiophene-2-carboxaldehyde are reacted with stirring in ethanol (EtOH). The reaction solution is filtered, and the resulting powder is washed with cold ethanol and recrystallized with methanol/ethanol to obtain the azomethine derivative (A) (see Scheme 3 above).

### [Binder Resin]

The toner of the present invention is composed of toner particles containing a binder resin together with the above-described light phase transition material that changes from a solid state to a liquid state by light irradiation.

When the toner of the present invention contains a binder resin, the toner has an appropriate viscosity, and bleeding when applied to paper is suppressed, so that fine line reproducibility and dot reproducibility are improved. As a toner production method, it is generally known that toner particles having a substantially uniform particle size and shape can be produced by utilizing a conventionally known emulsion aggregation method.

For example, with an azobenzene derivative having a structure represented by Formula (1) as an example of the above-described light phase transition material, due to molecular structure, toner particles cannot be produced using salting out in the emulsion aggregation method. However, by using a binder resin together with an azobenzene derivative, toner particles having a substantially uniform particle size and shape may be produced using salting out in an emulsion aggregation method. Therefore, a toner containing an azobenzene derivative and a binder resin may be easily applied as an electrostatic image developing toner.

In the present invention, as the binder resin, a resin generally used as the binder resin constituting the toner may be used without any limitation. Specific examples include a styrene resin, an acrylic resin, a styrene-acrylic resin, a polyester resin, a silicone resin, an olefin resin, an amide resin, and epoxy resin. These binder resins may be used alone or in combination of two or more.

In the present invention, among these binder resins, from the viewpoint of having a low viscosity when melted, having a high sharp melt property, and not hindering the measurement of ΔH1 (J/g) which is an endothermic amount based on a melting peak derived from a light phase transition material, the binder resin is preferably an amorphous binder resin. The amorphous binder resin applicable to the present invention preferably includes at least one selected from the group consisting of a styrene resin, an acrylic resin, a styrene-acrylic resin, and a polyester resin. More preferably, at least one selected from the group consisting of a styrene-acrylic resin and a polyester resin is included.

Hereinafter, a styrene-acrylic resin and a polyester resin, which are preferable binder resins, will be described.

### (Styrene-Acrylic Resin)

In the present invention, the styrene-acrylic resin is a resin formed by polymerization using at least a styrene monomer and a (meth)acrylate monomer. Here, the styrene monomer includes those having a structure having a known side chain or functional group in the styrene structure, in addition to styrene represented by the structural formula of CH₂═CH—C₆H₅.

The (meth)acrylate monomer has a functional group having an ester bond in the side chain. Specifically, in addition to the acrylate monomer represented by CH₂═CHCOOR (R is an alkyl group), a vinyl ester compound such as a methacrylate monomer represented by CH₂═C(CH₃)COOR (R is an alkyl group) is included.

Specific examples of the styrene monomer and (meth)acrylate monomer capable of forming a styrene-acrylic resin are indicated below, but the present invention is not limited to those indicated below.

Examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

As the (meth) acrylate monomer, the following acrylate monomer and methacrylate monomer are representative. Examples of the acrylate monomer include methyl acrylate, ethyl acrylate, n-propyl acrylate, isopropyl acrylate, n-butyl acrylate, isobutyl acrylate, tert-butyl acrylate, n-octyl acrylate, 2-ethylhexyl acrylate, stearyl acrylate, lauryl acrylate, and phenyl acrylate. Examples of the methacrylate monomer include methyl methacrylate, ethyl methacrylate, n-propyl methacrylate, isopropyl methacrylate, n-butyl methacrylate, isobutyl methacrylate, tert-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

These styrene monomers, acrylate monomers, or methacrylate monomers may be used alone or in combination of two or more.

The styrene-acrylic copolymer include the copolymer formed only with the styrene monomer and (meth)acrylate monomer described above. In addition, the copolymers formed with other general vinyl monomer, the styrene monomer and the (meth)acrylate monomer are also includes. Examples of vinyl monomers that may be used together when forming the styrene-acrylic copolymer referred to in the present invention are exemplified, but the vinyl monomers that may be used in combination with the present invention are not limited to those described below.
(1) Olefins: Ethylene, propylene, and isobutylene;
(2) Vinyl Esters: Vinyl propionate, vinyl acetate, and vinyl benzoate;
(3) Vinyl Ethers: Vinyl methyl ether, and vinyl ethyl ether;
(4) Vinyl Ketones: Vinyl methyl ketone, vinyl ethyl ketone, and vinyl hexyl ketone; and
(5)N-Vinyl Compounds: N-vinylcarbazole, N-vinylindole, and N-vinylpyrrolidon.
(6) Others: Vinyl compounds such as vinyl naphthalene and vinyl pyridine, acrylic acid or methacrylic acid derivatives such as acrylonitrile, methacrylonitrile and acrylamide.

It is also possible to produce a crosslinked resin using a polyfunctional vinyl monomer. Further, it is also possible to use a vinyl monomer having an ionic dissociation group in the side chain. Specific examples of the ionic dissociation group include a carboxy group, a sulfonic acid group, and a phosphoric acid group. Specific examples of these vinyl monomers having an ionic dissociation group are indicated below.

Specific examples of the vinyl monomer having a carboxy group include acrylic acid, methacrylic acid, maleic acid, itaconic acid, cinnamic acid, fumaric acid, maleic acid monoalkyl ester, and itaconic acid monoalkyl ester.

The method for forming the styrene-acrylic resin is not particularly limited, and examples thereof include a method of polymerizing a monomer using a known oil-soluble or water-soluble polymerization initiator. If necessary, a known chain transfer agent such as n-octyl mercaptan, n-octyl-3-mercaptopropionate may be used.

When forming the styrene-acrylic resin used in the present invention, the content of the styrene monomer and the acrylate monomer is not particularly limited. It is possible to adjust appropriately from the viewpoint of controlling the softening point temperature and the glass transition temperature of the binder resin. Specifically, the content of the styrene monomer is preferably 40 to 95 mass %, and preferably 50 to 80 mass % with respect to the whole monomer. In addition, the content of the acrylate monomer is preferably 5 to 60 mass %, and more preferably 10 to 50 mass %, based on the entire monomer.

A forming method of a styrene-acrylic resin is not limited in particular. It can be cited a polymerization method to polymerize a monomer using a publicly known oil-soluble polymerization initiator or a water-soluble polymerization initiator. Specific examples of the oil-soluble polymerization initiator include the following azo-based or diazo-based polymerization initiators and peroxide-based polymerization initiators.

Azo-based or diazo-based polymerization initiators are such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

Peroxide based polymerization initiators are such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine.

When the styrene-acrylic resin particles are formed by the emulsion polymerization method, a water-soluble polymerization initiator may be used. Specific examples of the water-soluble polymerization initiator include: persulfates such as potassium persulfate and ammonium persulfate; azobisaminodipropane acetate; azobiscyanovaleric acid and salts thereof; and hydrogen peroxide.

The polymerization temperature varies depending on the monomer used and the type of the polymerization initiator, and it is preferably 50 to 100° C., more preferably 55 to 90° C. The polymerization time varies depending on the type of monomer and polymerization initiator used, and it is preferably 2 to 12 hours, for example.

The styrene-acrylic resin particles formed by the emulsion polymerization method may have a structure of two or more layers made of resins having different compositions. As a production method in this case, it may be used the following multistage polymerization method. In a dispersion of resin particles prepared by emulsion polymerization treatment (first stage polymerization) according to a conventional method, a polymerization initiator and a polymerizable monomer are added, and this system is polymerized (second stage polymerization).

The glass transition temperature (Tg) of the styrene-acrylic resin is preferably in the range of 35 to 70° C., more preferably in the range of 40 to 60° C., from the viewpoints of fixability and heat-resistant storage stability. Tg may be measured by differential scanning calorimetry (DSC).

### (Polyester Resin)

The polyester resin is a known polyester resin obtained by the polycondensation reaction of a divalent or higher valent carboxylic acid (polyvalent carboxylic acid component) and an alcohol having a divalent or higher valent (polyhydric alcohol component). The polyester resin may be amorphous or crystalline

The number of valences of the polyvalent carboxylic acid component and the polyhydric alcohol component is preferably 2 to 3, and particularly preferably it is respectively 2. A case where the valence is 2 respectively (that is, a dicarboxylic acid component and a diol component) will be described as a particularly preferred form.

Examples of the dicarboxylic acid component include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicathoxylic acid, 1,14-tetradecanedicarboxylic acid, 1,16-hexadecanedicarboxylic acid, and 1,18-octadecanedicarboxylic acid; unsaturated aliphatic dicarboxylic acids such as methylenesuccinic acid, fumaric acid, maleic acid, 3-hexendiodic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, and anthracene dicarboxylic acid. In addition, lower alkyl esters and acid anhydrides of these compounds may also be used. The dicarboxylic acid components may be used alone or in combination of two or more.

In addition, trivalent or higher polyvalent carboxylic acids such as trimellitic acid and pyromellitic acid, anhydrides of the above carboxylic acid compounds, and alkyl esters having 1 to 3 carbon atoms may also be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosandiol, and neopentyl glycol; unsaturated aliphatic diols such as 2-butene-1,4-diol, 3-butene-1,4-diol, 2-butyne-1,4-diol, 3-butyne-1,4-diol, and 9-octadecene-7,12-diol; aromatic diols such as bisphenols (bisphenol A and bisphenol F), and alkylene oxide adducts of these compounds (ethylene oxide adduct and propylene oxide adduct), and derivatives thereof. The diol components may be used alone or in combination of two or more.

The production method of the polyester resin is not particularly limited, and examples thereof include a method of polycondensing (esterifying) the polyvalent carboxylic acid component and the polyhydric alcohol component using a known esterification catalyst.

Example of the catalyst which can be used for the synthesis of the crystalline polyester include: compounds of alkali metals such as sodium and lithium; compounds containing Group II elements, such as magnesium and calcium; compounds of metals, such as aluminum, zinc, manganese, antimony, titanium, tin, zirconium, and germanium; phosphite compounds; phosphate compounds; and amine compounds. Specific examples of tin compounds include: dibutyltin oxide, tin ocrylate, tin dioctylate, and salts thereof. Examples of titanium compounds include titanium alkoxides, such as tetra-n-butyl titanate (Ti(O-n-Bu)₄), tetraisopropyl titanate, tetramethyl titanate, and tetrastearyl titanate; titanium acylates, such as polyhydroxytitanium stearate; and titanium chelates, such as titanium tetraacetylacetonate, titanium lactate, and titanium triethanolaminate. Examples of germanium compounds include germanium dioxide. Examples of aluminum compounds include aluminum oxides, such as aluminum polyhydroxide; aluminum alkoxides; and tributyl aluminate. These may be used alone, or may be used in combination of two or more.

The polymerization temperature is not particularly limited, and i is preferably 70 to 250° C. The polymerization time is not particularly limited, and it is preferably 0.5 to 10 hours. During the polymerization, the pressure in the reaction system may be reduced as necessary.

The glass transition temperature (Tg) of the polyester resin is preferably in the range of 35 to 70° C., more preferably in the range of 40 to 60° C., from the viewpoints of fixability and heat storage stability. Tg may be measured by differential scanning calorimetry (DSC).

The toner of the present invention contains a binder resin, and the content ratio is preferably in the range of light phase transition material : binder resin=5:95 to 80:20 (mass ratio), more preferably in the range of 10:90 to 50:50. When it is this range, the light phase transition of a light phase transition material will occur easily, and the softening rate by the light irradiation of a toner will become sufficient. Moreover, it is excellent in fine line reproducibility and dot reproducibility.

Further, the toner of the present invention containing the light phase transition material and the binder resin may have a single layer structure or a core-shell structure. The type of the binder resin used for the core particle and the shell portion of the core-shell structure is not particularly limited.

### [Other Toner Components]

The electrostatic image developing toner of the present invention may contain other component in addition to the above-described light phase transition material and the binder resin.

### (Colorant)

The toner of the present invention may contain a colorant. As the colorant, generally known dyes and pigments may be used.

Examples of a colorant to obtain a black toner are: carbon black, a magnetic material, and iron-titanium complex oxide black. Examples of carbon black that may be used include: channel black, furnace black, acetylene black, thermal black, and lamp black. Examples of a magnetic material that may be used include: ferrite and magnetite.

Examples of a colorant to obtain a yellow toner are: dyes such as C. I. Solvent Yellow 19, 44, 77, 79, 81, 82, 93, 98, 103, 104, 112, and 162; and pigments such as C. I. Pigment Yellows 14, 17, 74, 93, 94, 138, 155, 180, and 185.

Examples of a colorant to obtain a magenta toner are: dyes such as C. I. Solvent Red 1, 49, 52, 58, 63, 111, and 122; and pigments such as C. I. Pigment Red 5, 48: 1, 53: 1, 57: 1, 122, 139, 144, 149, 166, 177, 178, and 222.

Examples of a colorant to obtain a cyan toner are: dyes such as C. I. Solvent Blue 25, 36, 60, 70, 93, and 95; and pigments such as C. I. Pigment Blue 1, 7, 15, 60, 62, 66, and 76.

One kind of colorant or a combination of two or more kinds of colorants may be used to obtain a toner of each color.

A content of the colorant in the toner with respect to the total mass of the toner is preferably in the range of 0.5 to 20 mass %, and more preferably in the range of 2 to 10 mass %.

### (Release Agent)

The toner of the present invention may contain a release agent. The release agent applicable to the present invention is not particularly limited, and various conventionally known waxes may be used.

Examples of the wax are: low molecular weight polypropylene, polyethylene or oxidized low molecular weight polypropylene, polyolefin such as polyethylene, paraffin, and synthetic ester wax. In particular, it is preferable to use a synthetic ester wax because of its low melting point and low viscosity, and it is particularly preferable to use behenyl behenate, glycerin tribehenate, or pentaerythritol tetrabehenate as the synthetic ester wax.

A content ratio of the release agent is preferably in the range of 1 to 30 mass % in the toner particles, more preferably it is in the range of 3 to 15 mass %.

### (Charge Controlling Agent)

The toner of the present invention may contain a charge controlling agent. The charge controlling agent applicable to the present invention is not particularly limited as long as it is a substance that is capable of providing positive or negative charge by a triboelectric charging, and colorless. Various known charge controlling agents that are positively chargeable or negatively chargeable may be used.

A content ratio of the charge controlling agent in the toner particles is preferably in the range of 0.01 to 30 mass %, and more preferably it is in the range of 0.1 to 10 mass % to the total mass of the toner particles.

### (External Additive)

In order to improve fluidity, charging property, and cleaning property of the toner particles, an external additive such as fluidity increasing agent and cleaning assisting agent may be added to the toner particles as an after treatment agent.

Examples of the external additive are: inorganic oxide particles such as silica particles, alumina particles, and titanium oxide particles; inorganic stearic acid compound particles such as aluminum stearate particles and zinc stearate particles; and inorganic particles of inorganic titanium acid compound particles such as strontium titanate particles and zinc titanate particles. These may be used alone, or they may be used in combination of two or more kinds.

The inorganic particles may be subjected to a surface treatment with a silane coupling agent, a titanium coupling agent, a higher fatty acid, or silicone oil in order to improve heat-resistant storage stability and environmental stability.

An addition amount of the external additive in the toner particles is preferably in the rage of 0.05 to 5 mass % to the total mass of the toner. More preferably, it is in the rage of 0.1 to 3 mass %.

### (Average Particle Size of Toner)

It is preferable that the toner particles of the present invention have an average particle size of 4 to 10 μm, more preferably 6 to 9 μm in volume-based median diameter (D₅₀). When the volume-based median diameter (D₅₀) is within the above-described range, the transfer efficiency is improved, the image quality of halftone is improved, and the image quality such as fine lines and dots is improved.

The volume-based median diameter (D₅₀) of the toner particles may be measured and calculated by using measuring equipment composed of a “COULTER COUNTER 3” (Beckman Coulter Inc.) and a computer system installed with data processing software “Software V3.51” (Beckman Coulter Inc.) connected thereto.

In a specific measuring process, 0.02 g of sample to be measured (the toner particles) is blended in 20 mL of the surfactant solution (for the purpose of dispersing toner particles, for example, a surfactant solution in which a neutral detergent including a surfactant component is diluted by 10 times with pure water), ultrasonic dispersion is performed for 1 minute and a toner particle dispersion liquid is prepared. This toner particle dispersion liquid is poured into a beaker including ISOTON II (manufactured by Beckman Coulter, Inc.) in the sample stand with a pipette until the measurement concentration is 8 mass %.

By setting this content range, it is possible to obtain a reproducible measurement value. Then, the liquid is measured by setting the counter of the particle to be measured to 25,000. The aperture diameter is set to be 50 um. The frequency count is calculated by dividing the range of the measurement range 1 to 30 μm by 256. The particle size where the accumulated volume counted from the largest size reaches 50% is determined as the volume-based median diameter (D₅₀).

### (Production Method of Toner)

There is no particular limitation on the production method applicable to the production of the toner of the present invention. For example, when a toner containing a light phase transition material, a colorant, and a binder resin is manufactured, a manufacturing method using an emulsion aggregation method in which the particle diameter and shape can be easily controlled is preferable.

The manufacturing method using the emulsion aggregation method includes the following steps.
(Step 1) Preparation step of each constituent particle dispersion
(1A) Binder resin particle dispersion preparing step for preparing binder resin particle dispersion
(1B) Colorant particle dispersion preparation step for preparing colorant particle dispersion
(1C) Light phase transition material particle dispersion preparation process for preparing a dispersion of light phase transition material particles;
(Step 2) Adding a flocculant into the aqueous medium in which components such as binder resin particles and, colorant particles, light phase transition material particles are present, and an associating process in which coagulation and fusion are performed simultaneously with the progress of salting out to form associated particles;
(Step 3) Aging step of forming toner particles by controlling the shape of the associated particles;
(Step 4) Filtration and washing step for separating the toner particles from the aqueous medium and removing the surfactant from the toner particles;
(Step 5) Drying step for drying the washed toner particles; and
(Step 6) External additive addition step of adding an external additive to the dried toner particles.

The details of (1A) to (1C), which are steps for preparing each constituent particle dispersion in (Step 1), will be described below.

### (1A) Preparation Step of Binder Resin Particle Dispersion

In this step, resin particles are formed by conventionally known emulsion polymerization, and the resin particles are aggregated and fused to form binder resin particles. As an example, a dispersion liquid of binder resin particles is prepared by charging and dispersing polymerizable monomers constituting the binder resin in an aqueous medium and polymerizing these polymerizable monomers with a polymerization initiator.

Further, as a method for obtaining a binder resin particle dispersion, there are the following methods in addition to the method of polymerizing a polymerizable monomer with a polymerization initiator in the above aqueous medium. For example, there is a method of performing dispersion treatment in an aqueous medium without using a solvent. Otherwise, there is a method in which a crystalline resin is dissolved in a solvent such as ethyl acetate to form a solution, and emulsifying and dispersing the solution in an aqueous medium using a disperser, thereafter, performing a solvent removal treatment.

At this time, if necessary, the binder resin may contain a release agent in advance. In addition, for dispersion, polymerization is appropriately performed in the presence of a known surfactant (for example, an anionic surfactant such as sodium polyoxyethylene (2) dodecyl ether sulfate, sodium dodecyl sulfate, and dodecylbenzene sulfonic acid).

The volume-based median diameter of the binder resin particles in the dispersion is preferably in the range of 50 to 300 nm. The volume-based median diameter of the binder resin particles in the dispersion can also be measured by a dynamic light scattering method using “MICROTRAC UPA-150” (manufactured by Nikkiso Co., Ltd.).

### (1B) Preparation Step of Colorant Particle Dispersion

This preparing process of the colorant particle dispersion is a step of preparing a dispersion of colorant particles by dispersing the colorant in the form of fine particles in an aqueous medium.

The colorant may be dispersed using mechanical energy. The number-based median diameter of the colorant particles in the dispersion is preferably in the range of 10 to 300 nm, and more preferably in the range of 50 to 200 nm. The number-based median diameter of the colorant particles may be measured using an electrophoretic light scattering photometer “ELS-800” (manufactured by Otsuka Electronics Co., Ltd.).

### (1C) Preparation Step of Light Phase Transition Material Particle Dispersion

This preparing process of the phase transition material particle dispersion is a step of preparing a dispersion of the phase transition material dispersion particles by dispersing the phase transition material particles in the form of fine particles in an aqueous medium. In preparing the light phase transition material particle dispersion, first, a light phase transition material emulsion is prepared. As a method for preparing a light phase transition material emulsion, there is cited the following method. After obtaining a light phase transition material solution in which a light phase transition material, for example, an azobenzene derivative is dissolved in an organic solvent, the light phase transition material solution is placed in an aqueous medium, then it is emulsified in the aqueous medium.

The method for dissolving the light phase transition material in the organic solvent is not particularly limited. There is a method in which a light phase transition material, for example, an azobenzene derivative is added to an organic solvent and stirred and mixed so that the azobenzene derivative is dissolved. The addition ratio of the light phase transition material is preferably in the range of 5 to 100 mass parts, more preferably in the range of 10 to 50 mass parts with respect to 100 mass parts of the organic solvent.

Next, the light phase transition material solution and the aqueous medium are mixed and stirred using a known disperser such as a homogenizer. Thereby, the light phase transition material becomes a droplet, is emulsified in an aqueous medium, and a light phase transition material emulsion is prepared.

The addition ratio of the light phase transition material solution is preferably in the range of 20 to 200 mass parts, more preferably in the range of 50 to 100 mass parts with respect to 100 mass parts of the aqueous medium.

In addition, the temperature of each of the light phase transition material solution and the aqueous medium when the light phase transition material solution and the aqueous medium are mixed is a temperature range that is less than the boiling point of the organic solvent. Preferably it is in the range of 20 to 80° C., more preferably in the range of 30 to 75° C. The temperature of the light phase transition material solution and the temperature of the aqueous medium when mixing the light phase transition material solution and the aqueous medium may be the same as or different from each other, and preferably the same.

As for the stirring conditions of the disperser, for example, when the capacity is 1 to 3 L, the rotational speed is preferably in the range of 7000 to 20000 rpm, and the stirring time is preferably in the range of 10 to 30 minutes.

The light phase transition material particle dispersion is prepared by removing the organic solvent from the light phase transition material emulsion. Examples of the method for removing the organic solvent from the light phase transition material emulsion include known methods such as blowing, heating, decompression, or a combination thereof.

As an example, the emulsion of the light phase transition material is preferably heated in an inert gas atmosphere such as nitrogen, preferably in the range of 25 to 90° C., more preferably in the range of 30 to 80° C. The organic solvent is removed by heating until removing the initial content in the range of 80 to 95 mass %. Thereby, the organic solvent is removed from the aqueous medium, and the light phase transition material particle dispersion liquid in which the light phase transition material particles are dispersed in the aqueous medium is prepared.

The mass average particle size of the light phase transition material particles in the light phase transition material particle dispersion is preferably in the range of 90 to 1200 nm. The mass average particle size of the light phase transition material particles may be set in the above-described range by appropriately controlling the viscosity when the light phase transition material is blended in an organic solvent, the blending ratio of the light phase transition material solution and water, and the stirring speed of the machine when preparing the light phase transition material emulsion. The mass average particle size of the light phase transition material particles in the light phase transition material particle dispersion may be measured using an electrophoretic light scattering photometer “ELS-800” (manufactured by Otsuka Electronics Co., Ltd.).

### <Organic Solvent>

The organic solvent used in the toner production process is not particularly limited as long as it can dissolve the light phase transition material according to the present invention. Specifically, the following solvents may be cited: esters such as ethyl acetate and butyl acetate, ethers such as diethyl ether, diisopropyl ether and tetrahydrofuran, ketones such as acetone and methyl ethyl ketone, saturated hydrocathons such as hexane and heptane, and halogenated hydrocarbons such as dichloromethane, dichloroethane, and carbon tetrachloride.

Such organic solvents can be used alone or in combination of two or more. Among these organic solvents, ketones and halogenated hydrocathons are preferable, and methyl ethyl ketone and dichloromethane are more preferable.

### <Aqueous Medium>

The aqueous medium used in the production process of the toner is water or an aqueous medium containing water as a main component and water-soluble solvents such as alcohols and glycols, and optional components such as surfactants and dispersants. As the aqueous medium, a mixture of water and a surfactant is preferably used.

The surfactant may be a cationic surfactant, an anionic surfactant, or a nonionic surfactant. Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactant include fatty acid soaps such as sodium stearate and sodium dodecanoate, sodium dodecylbenzenesulfonate, and sodium dodecylsulfate. Examples of the nonionic surfactant include polyoxyethylene dodecyl ether, polyoxyethylene hexadecyl ether, polyoxyethylene nonyl phenyl ether, polyoxyethylene dodecyl ether, polyoxyethylene sorbitan monooleate ether, and monodecanoyl sucrose.

These surfactants may be used alone or in combination of two or more. Among them, preferably an anionic surfactant, more preferably sodium dodecylbenzenesulfonate is used.

The addition amount of the surfactant is preferably in the range of 0.01 to 1 mass part, more preferably in the range of 0.04 to 1 mass part with respect to 100 mass parts of the aqueous medium.

From (Step 2) Association step to (Step 6) External additive addition step may be performed according to various conventionally known methods.

In addition, the flocculant used in the (Step 2) Association step is not particularly limited, but those selected from metal salts are preferably used. Examples of metal salts include: monovalent metal salts such as alkali metal salts such as sodium, potassium and lithium; divalent metal salts such as calcium, magnesium, manganese and copper; and trivalent metal salts such as iron and aluminum. Specifically, examples of the metal salt include sodium chloride, potassium chloride, lithium chloride, calcium chloride, magnesium chloride, zinc chloride, copper sulfate, magnesium sulfate, and manganese sulfate. Among them, a divalent metal salt is particularly preferable because aggregation can be promoted with a smaller amount. These may be used alone or in combination of two or more.

### [Developer]

The toner of the present invention may be used, for example, as a one-component magnetic toner containing a magnetic material, as a two-component developer mixed with a so-called carrier, or as a non-magnetic toner used alone. Any of these may be suitably used.

Examples of the magnetic material contained in the one-component developer include magnetite, y-hematite, and various ferrites.

As the carrier constituting the two-component developer, magnetic particles made of conventionally known materials such as metals such as iron, steel, nickel, cobalt, ferrite, and magnetite, and alloys of these metals with metals such as aluminum and lead may be used.

The carrier particles are preferably coated carrier particles obtained by coating the surfaces of magnetic particles with a coating agent such as a resin, or resin-dispersed carrier particles in which magnetic powder is dispersed in a binder resin. Although the coating resin is not limited, examples of the coating resin include an olefin resin, an acrylic resin, a styrene resin, styrene-acrylic resin, a silicone resin, a polyester resin, or a fluorine resin. Although the resin constituting the resin-dispersed carrier particles is not limited, any known resin may be used. Examples of the resin constituting the resin-dispersed carrier particles include an acrylic resin, a styrene-acrylic resin, a polyester resin, a fluororesin, and a phenol resin.

The volume-based median diameter of the carrier particles is preferably in the range of 20 to 100 gm, and more preferably in the range of 25 to 80 gm. The volume-based median diameter of the carrier particles may be typically measured by a laser diffraction particle size distribution measuring apparatus “HELOS” (manufactured by SYMPATEC Co., Ltd.) equipped with a wet disperser.

The content of the toner in the developer is preferably in the range of 2 to 10 mass % with respect to 100 mass % of the total mass of the toner and the carrier.

### <<Image Forming Method>>

The toner of the present invention may be used in various known electrophotographic image forming methods, for example, in a monochrome image forming method or in a full color image forming method. In the full-color image forming method, the present invention may be applied to any image forming method such as a four-cycle type image forming method including four types of color developing devices for each of yellow, magenta, cyan, and black, and one photoconductor; and a tandem image forming method in which an image forming unit having a color developing device and a photoconductor for each color is mounted for each color.

The image forming method of the present invention includes: a step of forming a toner image comprising the toner of the present invention on a recording medium; and a step of irradiating the formed toner image with light to soften the toner image, thereby fixing the toner image on the recording medium. As a wavelength of the light to irradiate, it is a preferable aspect that it is 280 nm or more and less than 480 nm.

### [Overview of Image Forming Apparatus]

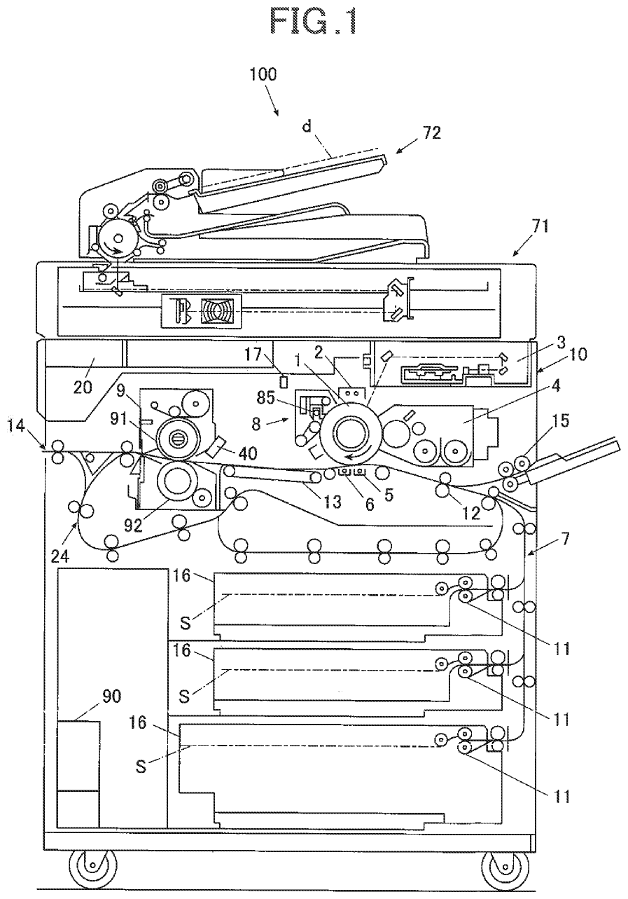

FIG. 1 is a schematic configuration diagram illustrating an image forming apparatus 100 used in an image forming method according to an embodiment of the present invention. However, the image forming apparatus used in the present invention is not limited to the following forms and illustrated examples. FIG. 1 illustrates an example of a monochrome image forming apparatus 100, but the present invention may also be applied to a color image forming apparatus.

The image forming apparatus 100 is an apparatus that forms an image on a recording sheet S as a recording medium. The image forming apparatus 100 includes an image reading device 71 and an automatic document feeder 72, and an image is formed on the recording sheet S conveyed by the sheet conveying system 7 by an image forming unit 10, a irradiation unit 40, and a pressure bonding unit 9.

Further, although the recording sheet S is used as the recording medium in the image forming apparatus 100, the medium on which image formation is performed may be other than the recording sheet.

The image reading device 71 includes a scanning exposure device, an image sensor CCD, and an image processing unit 20. Then, the document d placed on the document table of the automatic document feeder 72 is conveyed to the image reading device 71, scanned and exposed by an optical system of the scanning exposure device, and read into the image sensor CCD. The analog signal photoelectrically converted by the image sensor CCD is subjected to analog processing, A/D conversion, shading correction, and image compression processing in the image processing unit 20 and then input to the exposure device 3 of the image forming unit 10.

The paper transport system 7 includes a plurality of trays 16, a plurality of paper feeding units 11, a transport roller 12, and a transport belt 13. The tray 16 accommodates recording paper S of a predetermined size, and operates the paper supply unit 11 of the tray 16 determined according to an instruction from the control unit 90 to supply the recording paper S. The conveyance roller 12 conveys the recording paper S sent out from the tray 16 by the paper feeding unit 11 or the recording paper S carried in from the manual paper feeding unit 15 to the image forming unit 10.

In the image forming unit 10, a charger 2, an exposure unit 3, a developing unit 4, a transfer unit 5, a charge eliminating unit 6, and a cleaning unit 8 are arranged in this order around the photoreceptor 1 along the rotation direction of the photoreceptor 1.

### [Irradiation Unit]

Next, the irradiation unit 40 that softens the toner image by irradiating the toner image with light after forming the toner image on the recording paper will be described.

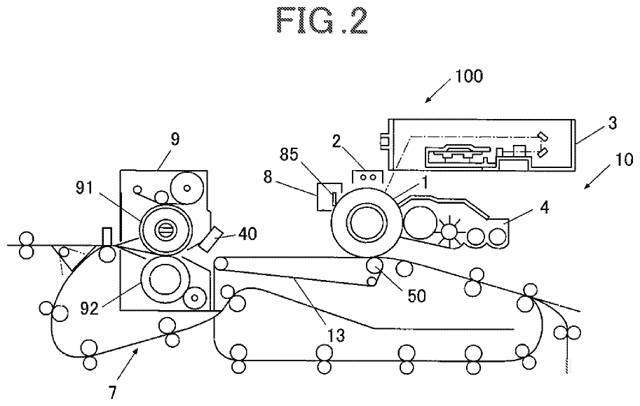

FIG. 2 is a partially enlarged view illustrating a peripheral configuration of the image forming unit 10, the irradiation unit 40, and the pressure bonding unit 9.

In the image forming unit 10, a charger 2, an exposure unit 3, a developing unit 4, a transfer unit 5, a charge eliminating unit 6, and a cleaning unit 8 are arranged in this order around the photoreceptor 1 along the rotation direction of the photoreceptor 1.

The photoreceptor 1 is an image carrier having a photoconductive layer formed on the surface thereof, and is configured to be rotatable in the direction of the arrow in FIG. 1 by a driving device (not shown). A thermohygrometer 17 that detects the temperature and humidity in the image forming apparatus 100 is provided in the vicinity of the photoreceptor 1.

The charger 2 uniformly charges the surface of the photoreceptor 1 and charges the surface of the photoreceptor 1 uniformly.

The exposure device 3 includes a beam emission source such as a laser diode. The exposure unit 3 irradiates the charged surface of the photoreceptor 1 with the beam light, thereby erasing the charge of the irradiated portion. An electrostatic latent image is formed.

The developing unit 4 supplies toner contained therein to the photoreceptor 1 to form a toner image based on the electrostatic latent image on the surface of the photoreceptor 1.

The transfer unit 5 is disposed to face the photoreceptor 1 with the recording paper S interposed therebetween, and transfers the toner image to the recording paper S.

The charge eliminating unit 6 performs neutralization on the photoreceptor 1 after the toner image is transferred.

The cleaning unit 8 includes a blade 85. The surface of the photoreceptor 1 is cleaned by the blade 85 to remove the developer remaining on the surface of the photoreceptor 1.

The irradiation unit 40 is a light source that irradiates light onto the toner image formed on the recording paper S. Specifically, the irradiation unit 40 is disposed on the photoreceptor 1 side with respect to the recording paper S surface nipped between the photoreceptor 1 and the transfer roller 50. The irradiation unit 40 is disposed between the nip position (formed by the photoreceptor 1 and the transfer roller 50) and the pressure bonding unit 9 in the paper transport direction.

The irradiation unit 40 melts a compound (for example, an azobenzene derivative) that undergoes phase transition by light absorption contained in the developer. The irradiation unit 40 preferably emits ultraviolet light having a wavelength in the range of 280 nm or more and less than 480 nm, more preferably in the range of 330 nm or more and less than 390 nm. The irradiation amount of the ultraviolet light in the irradiation unit 40 is preferably in the range of 0.1 to 200 J/cm², more preferably in the range of 0.5 to 100 J/cm², and still more preferably in the range of 1.0 to 50 J/cm².

Examples of the irradiation unit 40 include a light emitting diode (LED) and a laser light source. Thereby, the toner image containing the compound that undergoes phase transition is melted or softened, and the toner image is fixed on the recording paper S. The wavelength of light to be irradiated and the irradiation amount are as described above.

The pressure bonding unit 9 is arbitrarily installed, and a fixing process is performed on the recording paper S on which the toner image is transferred by applying pressure alone or heat and pressure by the pressure members 91 and 92, thereby the image is fixed on the paper S. The recording sheet S on which the image is fixed is transported to the paper discharge unit 14 by the transport roller, and is discharged from the paper discharge unit 14 to the outside of the apparatus.

Further, the image forming apparatus 100 includes a paper reversing unit 24. As a result, the recording sheet S that has been heat-fixed is conveyed to the sheet reversing unit 24 in front of the paper discharge unit 14, and is discharged with the front and back reversed, or the recording sheet S with the front and back reversed is again formed in the image forming unit 10, and image formation can be performed on both sides of the recording paper S.

An image forming method using the image forming apparatus illustrating in FIG. 1 will be described below.

First, the charger 2 is charged by applying a uniform potential to the photoreceptor 1 and then scanned on the photoreceptor 1 with a light beam irradiated by the exposure device 3 based on the original image data, thereby forming an electrostatic latent image.

Next, a developer containing a compound that undergoes phase transition by light absorption is supplied onto the photoreceptor 1 by the developing unit 4.

When the recording sheet S is conveyed from the tray 16 to the image forming unit 10 in accordance with the timing at which the toner image carried on the surface of the photoreceptor 1 reaches the position of the transfer roller 50 by the rotation of the photoreceptor 1, the toner image on the photoreceptor 1 is transferred onto the recording sheet S nipped between the transfer member 50 and the photoreceptor 1 by the applied transfer bias.

The transfer roller 50 also serves as a pressure member, and securely transfers the toner image to the recording paper S while transferring the toner image from the photoreceptor 1 to the recording paper S.

After the toner image is transferred to the recording paper S, the blade 85 of the cleaning unit 8 removes the developer remaining on the surface of the photoreceptor 1.

In this way, the recording paper S to which the toner image has been transferred is conveyed to the irradiation unit 40 and the pressure bonding unit 9 by the conveyance belt 13.

The irradiation unit 40 irradiates the toner image transferred onto the recording paper S with light (preferably light in the range of 280 to 480 nm). Since the toner image is melted and softened by irradiating the toner image on the recording paper S with the irradiation unit 40, the toner image is fixed to the recording paper S.

When the recording paper S on which the toner image is held reaches the pressure bonding unit 9 by the conveying belt 13, the recording paper S on which the toner image is formed is pressure-bonded by the pressure member 91 and the pressure member 92. Since the toner image is softened by light irradiation by the irradiation unit 40 before being pressed by the pressure bonding unit 9, the toner image on the recording paper S can be pressed with lower energy.

The pressure at the time of pressurizing the toner image is as described above. The pressurizing step may be performed before or simultaneously with or after the step of softening the toner image by irradiating light. From the viewpoint of being able to pressurize the toner image that has been softened in advance and easily increasing the image intensity, the pressurizing step is preferably performed after light irradiation.

The pressure member 91 can heat the toner image on the recording paper S when the recording paper S passes between the pressure member 91 and the pressure member 92. The toner image softened by the light irradiation is further softened by this heating, and as a result, the fixability (image strength) of the toner image to the recording paper S is further improved.

The heating temperature of the toner image is as described above. The heating temperature of the toner image (the surface temperature of the toner image) can be measured with a non-contact temperature sensor. Specifically, for example, a non-contact temperature sensor may be installed at a position where the recording medium is discharged from the pressure member, and the surface temperature of the toner image on the recording medium may be measured.

The toner images pressed by the pressure member 91 and the pressure member 92 are solidified and fixed on the recording paper S.

### EXAMPLES

Hereinafter, the present invention will be specifically described with reference to examples, but the present invention is not limited thereto. Unless otherwise specified, “%” and “part” mean “mass %” and “mass part”, respectively.

### <<Preparation of Each Constituent Material>>

### [Preparation of Light Phase Transition Material]

### (Preparation of Azobenzene Derivative (1))

An azobenzene derivative (1) as an exemplary compound was prepared according to the following method.

As described above, according to the following Reaction Scheme A, 4-aminophenol was reacted with sodium nitrite under cooling to form a diazonium salt. This was reacted with o-cresol to synthesize intermediate A (first step), and then n-bromohexane is allowed to react with the intermediate A (second step). Thus, the above azobenzene derivative (1) having a number average molecular weight Mn of 369 was obtained.

The melting point Tm measured using differential scanning calorimetry (DSC) was 87° C.

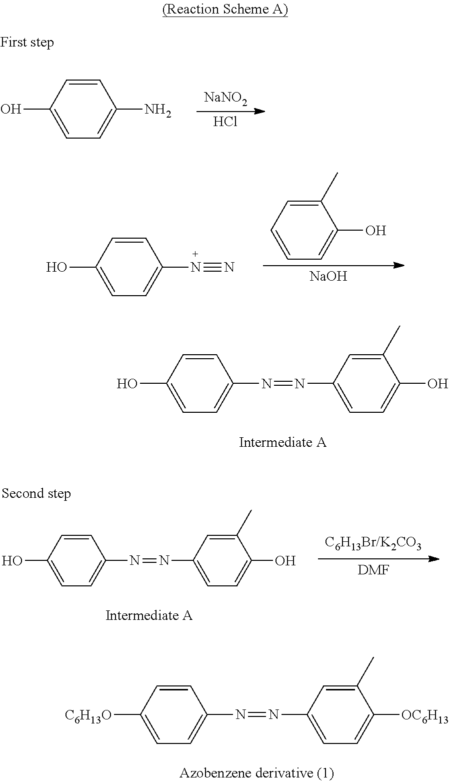

### (Preparation of Azobenzene Derivative (3))

An azobenzene derivative (3) as an exemplary compound was prepared according to the following method.

The azobenzene derivative (3) described below was prepared in the same manner as preparation of the azobenzene derivative (1) except that n-bromohexane to be reacted with the Intermediated A in the Reaction Scheme A was changed to n-bromododecane. The azobenzene derivative (3) had a number average molecular weight Mn of 746 and a melting point of 72° C.

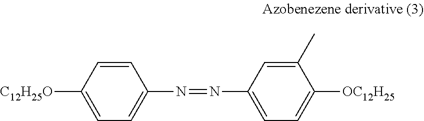

### (Preparation of Azobenzene Derivative (9))

An azobenzene derivative (9) as an exemplary compound was prepared according to the following method.

In the Reaction Scheme A described in the preparation of the azobenzene derivative (1), 4-aminophenol was converted to 4-amino-orthocresol, o-cresol was converted to 2-tert-butylphenol, and n-bromohexane was converted to n-bromododecane. The following azobenzene derivative (9) having a number average molecular weight Mn of 802 and a melting point Tm of 97° C. was prepared in the same manner except that each was changed.

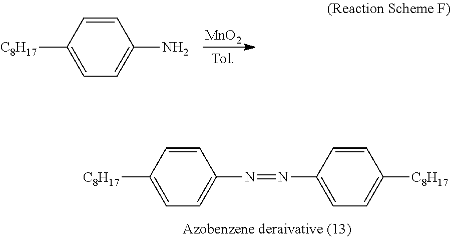

### (Preparation of Azobenzene Derivative (13))

An azobenzene derivative (13) as an exemplary compound was prepared according to the following method.

According to Reaction Scheme F indicated below, p-octylaniline was reacted with manganese dioxide as an oxidizing agent to prepare the following azobenzene derivative (13) having a number average molecular weight Mn of 406 and a melting point Tm of 52° C.

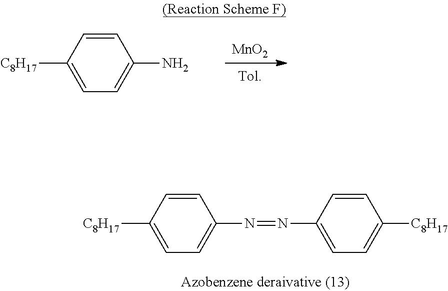

### (Preparation of Azomethine Derivative (A))

An azomethine derivative (A), which is the exemplified compound described above, was prepared according to the following method. The number average molecular weight Mn of the azomethine derivative (A) is 285, and the melting point Tm is 63° C.

According to the following Reaction Scheme E, raw materials 4-nitrophenol and 1-iodohexane (C₆H₃₃I) were reacted by heating under reflux using potassium carbonate (K2CO3) in dimethylformamide (DMF), and the reaction solution was washed with water. By concentrating and purifying, 4-hexyloxynitrobenzene was obtained (see Scheme 1 below).

Next, in a mixed solvent of ethanol (EtOH) and tetrahydrofuran (THF), the reaction was performed while enclosing hydrogen gas (H₂) against 4-hexyloxynitrobenzene obtained in Scheme 1 under palladium on carbon (Pd/C catalyst) with stirring. 4-(Hexyloxy)aniline was obtained by removing the catalyst from the reaction solution, concentrating the solution, and recrystallizing with ethanol (see Scheme 2 above).

Subsequently, 4-(hexyloxy)aniline obtained in Scheme 2 and 5-methoxythiophene-2-carboxaldehyde were reacted with stirring in ethanol (EtOH). The reaction solution was filtered, and the resulting powder was washed with cold ethanol and recrystallized with methanol/ethanol to obtain the azomethine derivative (A) (see Scheme 3 above).

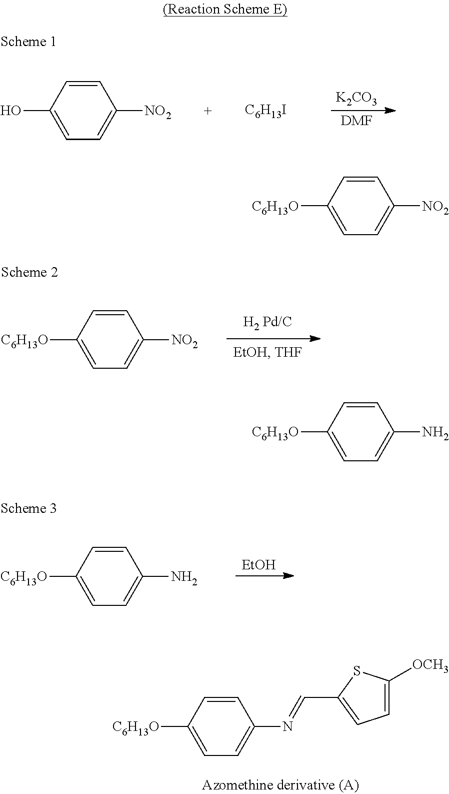

### [Preparation of Binder Resin]

### [Preparation of Binder Resin 1]

### (Preparation of Styrene-Acrylic Resin Particle Dispersion 1 Containing Styrene-Acrylic Rresin)

### (1) First Stage Polymerization

Into a reaction vessel equipped with a stirrer, a temperature sensor, a cooling tube and a nitrogen introducing device, a solution prepared by dissolving 8 mass part of sodium polyoxyethylene-2-dodecyl ether sulfate in 3,000 mass parts of ion-exchanged water was charged. The inner temperature was raised to 80° C. while stirring at a stirring speed of 230 rpm under a nitrogen stream. After the temperature increase, a solution prepared by dissolving 10 mass parts of potassium persulfate in 200 mass parts of ion-exchanged water was added, and the liquid temperature was made to 80° C. again. Thereafter, a monomer mixed solution consisting of 480 mass parts of styrene, 250 mass parts of n-butyl acrylate and 68.0 mass parts of methacrylic acid, and 16.0 mass parts of n-octyl-3-mercaptopropionate was added dropwise over 1 hour. After completion of the dropping, polymerization (first stage polymerization) was performed by heating and stirring at 80° C. for 2 hours to prepare a styrene-acrylic resin particle dispersion (1A) containing styrene-acrylic resin particles (la).

### (2) Second Stage Polymerization

Into a reaction vessel equipped with a stirrer, a temperature sensor, a cooling tube and a nitrogen introducing device, a solution obtained by dissolving 7 mass parts of polyoxyethylene-2-dodecyl ether sulfate in 800 mass part of ion-exchanged water was charged. This was heated to 98° C. Then, a monomer mixed solution containing 260 mass parts of the above-obtained styrene-acrylic resin particle dispersion (1A), 245 mass parts of styrene, 120 mass parts of n-butyl acrylate, 1.5 mass part of n-octyl-3-mercaptopropionate dissolved at 90° C. was added. The reaction system was mixed and dispersed for 1 hour by using a mechanical disperser with a circulation route “CLEARM IX” (manufactured by M Technique Co. Ltd.) so that a dispersion liquid containing emulsion particles (oil particles) was prepared.

Next, an initiator solution in which 6 mass part of potassium persulfate was dissolved in 200 mass parts of ion-exchanged water was added to this dispersion, and the system was heated and stirred at 82° C. for 1 hour. The polymerization (second stage polymerization) was carried out. Thus, a styrene-acrylic resin particle dispersion (1B) containing styrene-acrylic resin particle was prepared.

### (3) Third Stage Polymerization

An initiator solution prepared by dissolving 11 mass parts of potassium persulfate in 400 mass parts of ion-exchanged water was added to the styrene-acrylic resin article dispersion (1B) obtained above. Under the temperature condition of 82° C., a monomer mixed solution containing 435 mass parts styrene, 130 mass parts of n-butyl acrylate, 33 mass parts of methacrylic acid and 8 mass parts of n-octyl-3-mercaptopropionate was added dropwise over 1 hour. After completion of the dropping, polymerization (third stage polymerization) was performed by heating and stirring for 2 hours. Then, by cooling to 28° C., a styrene-acrylic resin particle dispersion 1 containing styrene-acrylic resin was prepared. Further, the softening point temperature (Tsp) of the styrene-acrylic resin 1 as the binder resin 1 was measured by the following method, and it was 105° C.

### (Measurement of Softening Point Temperature (Tsp) of Binder Resin)

In an environment of a temperature of 20 ±1° C. and a relative humidity of 50 ±5%RH, 1.1 g of binder resin 1 was placed in a petri dish and leveled, and left for 12 hours or more. Thereafter, using a molding machine “SSP-10A” (manufactured by Shimadzu Corporation), it was pressurized with a force of 3820 kg/cm² for 30 seconds to create a cylindrical molded sample with a diameter of 1 cm. Next, this molded sample was measured with a flow tester “CFT-500D” (manufactured by Shimadzu Corporation) in an environment of a temperature of 24 ±5° C. and a relative temperature of 50±20%RH. Under the conditions of a load of 196 N (20 kgf), a starting temperature of 60° C., a preheating time of 300 seconds, and a heating rate of 6° C./min, the sample was extruded from the hole of the cylindrical die (1 mm diameter×1 mm) from the end of preheating using a 1 cm diameter piston. The offset method temperature T_{offset} measured at a setting of an offset value of 5 mm by the melting temperature measurement method of the temperature raising method was used as the softening point of the binder resin 1.

### [Preparation of Binder Resins 2 to 7]

In the preparation of the binder resin 1, the amounts of styrene, n-butyl acrylate and methacrylic acid used in the first stage polymerization, second stage polymerization, and third elastic polymerization and the liquid temperature conditions were changed as indicated in Table I. The styrene-acrylic resin particle dispersions 2 to 7 containing the binder resins 2 to 7 were prepared in the same manner as preparation of the binder resin 1 except that they were appropriately changed as indicated in Table I.

### [Preparation of Light Phase Transition Material Particle Dispersion]

### [Preparation of Light Phase Transition Material Particle Dispersion 1]

80 mass parts of dichloromethane and 20 mass parts of azobenzene derivative (1), which was the above prepared light phase transition material, were mixed and stirred while heating at 50° C. to prepare a solution containing the light phase transition material.

A mixed solution of 99.5 mass parts of distilled water warmed to 50° C. and 0.5 mass parts of a 20 mass % of aqueous sodium dodecylbenzenesulfonate solution was added to 100 mass parts of the solution obtained above. Thereafter, the mixture was stirred and emulsified at 16000 rpm for 20 minutes with a homogenizer (manufactured by Heidorf Co. Ltd.) equipped with a shaft generator 18F to obtain an emulsion of the light phase transition material.

The obtained emulsified liquid of the light phase transition material was placed into a separable flask, and the organic solvent was removed by heating and stirring at 40° C. for 90 minutes while supplying nitrogen into the gas phase to obtain a light phase transition material particle dispersion 1. The particle size of the light phase transition material particles in the light phase transition material particle dispersion 1 was measured using an electrophoretic light scattering photometer “ELS-800” (manufactured by Otsuka Electronics Co., Ltd.). It was 183 mn.

### (Preparation of Light Phase Transition Material Particle Dispersions 2 to 5)

Light phase transition material particle dispersions 2 to 5 were prepared in the same manner as in the preparation of the light phase transition material particle dispersion 1, except that the light phase transition material was changed to the light phase transition material described in Table I.

### <<Preparation of Toner>>

### [Preparation of Toner 1]

In a reaction vessel equipped with a stirrer, a temperature sensor, and a cooling tube, 432 mass parts (in terms of solid content) of styrene-acrylic resin particle dispersion 1, 288 mass parts (in terms of solid content) of the light phase transition material particle dispersion 1 (azobenzene derivative (1)), and 900 mass parts of ion-exchanged water were charged. Then, while keeping the inner temperature to be 30° C., 5 mol/L sodium hydroxide aqueous solution was added under stirring at 150 rpm, and pH was adjusted to 10.

Then, an aqueous solution in which 2 mass parts of magnesium chloride hexahydrate was dissolved in 1000 mass parts of ion-exchanged water was stirred and added over 10 minutes. After addition, the temperature was raised to 70° C. over 60 minutes, and the particle growth reaction was continued while maintaining 70° C. In this state, the particle size of the associated particles was measured with “COULTER MULTISIZER 3” (manufactured by Coulter Beckman), and when the volume-based median diameter (D50) became 6.5 μm, particle growth was stopped by adding an aqueous solution in which 190 mass parts of sodium chloride was dissolved in 760 mass parts of ion-exchanged water.

Next, after stirring at 70° C. for 1 hour, the temperature was further raised, and the particles were fused by heating and stirring at 75° C. Thereafter, the mixture was cooled to 30° C. to obtain a dispersion of toner particles.

The toner particle dispersion obtained above was solid-liquid separated with a centrifugal separator to form a toner particle wet cake. The wet cake was washed with ion-exchanged water at 35° C. until the electric conductivity of the filtrate reached 5 μS/cm in the centrifuge, and then transferred to “FLASH JET dryer (manufactured by Seishin Enterprise Co., Ltd.)”. The toner particles were prepared by drying until the water amount became 0.5 mass %. 1 mass % of hydrophobic silica (number average primary particle size: 12 nm) and 0.3 mass % of hydrophobic titania (number average primary particle size: 20 nm) were added to the obtained toner particles. Toner particles 1 were obtained by mixing using a HENSCHEL Mixer (registered trademark)

The volume-based median diameter (D50) (average particle size of the toner) of Toner 1 was measured using “COULTER COUNTER 3” (manufactured by Beckman Coulter, Inc.) and found to be 7.6 μm. The mass ratio of the azobenzene derivative (1), which is a light phase transition material in the toner 1, to the binder resin 1 was 40:60 (mass %).

### [Preparation of Toners 2 to 10]

Toners 2 to 10 were prepared in the same mariner as the preparation of the toner 1 except that the following changes were made. In the preparation of the toner 1, the type of the light phase transition material particle dispersion, the type of the styrene-acrylic resin particle dispersion, and the composition ratio of the light phase transition material and the styrene-acrylic resin were set as indicated in Table I.

### [Measurement of Endothermic Amounts ΔH1 and ΔH2]

For each of the toners prepared above, an endothermic amount ΔH1 (J/g) and an endothermic amount ΔH2 (J/g) based on a melting peak derived from the light phase transition material were measured according to the following method.

As a differential scanning calorimeter of the toner, “Diamond DSC” (manufactured by PerkinElmer, Inc.) was used, and 3.0 mg of toner was sealed in an aluminum pan and set in a sample holder of “Diamond DSC”. An empty aluminum pan was used as a reference.

Next, the temperature was raised from 25° C. to 200° C. at an elevation rate of 10° C./min, and the endothermic amount ΔH1 (J/g) based on the melting peak derived from the light phase transition material was measured from the obtained DSC curve.

Next, after isothermal holding at 200° C. for 5 minutes, cooling was performed from 200° C. to 0° C. at a cooling rate of 10° C./min, and the isothermal holding was performed at 0° C. for 5 minutes. In the second temperature raising process for raising the temperature to 200° C., the endothermic amount ΔH2 (J/g) based on the melting peak derived from the light phase transition material was measured.

### <<Preparation of Developer>>

Using the toners 1 to 10 prepared as described above, a ferrite carrier coated with a copolymer resin of cyclohexane methacrylate and methyl methacrylate (monomer mass ratio 1:1) and having a volume average particle size of 30 μm was mixed with the toner so as to produce developers 1 to 10 each having a toner concentration of 6 mass %. Mixing was performed for 30 minutes using a V-type mixer.

### <<Evaluation of Toner>>

### [Fixability Test]

The fixability test was performed in a normal temperature and humidity environment (temperature 20° C., humidity 50%RH) using the developer prepared above. Between a pair of parallel plate (aluminum) electrodes with the developer on one side and a plain paper (basis weight: 64 g/m²) on the other side, the developer was placed while sliding by magnetic force. The toner was developed under the condition that the gap between the electrodes was 0.5 mm, and the DC bias and AC bias were set so that the toner adhesion amount became 4 g/m² to form a toner layer on the paper surface. Using the fixing device illustrated in FIG. 2, fixing was performed under the fixing device conditions indicated in Table Ito produce printed materials 1 to 13.

The 1 cm square toner image of the printed material was rubbed 10 times with “JK Wiper (registered trademark)” (manufactured by Nippon Paper Crecia Co., Ltd.) under a pressure of 15 kPa, and the image fixing rate was evaluated. A fixing rate of 70% or more was considered acceptable. The image fixing rate was determined as follows. The reflection density of the image after printing and the reflection density of the image after rubbing were measured with a fluorescence spectral densitometer “FD-7” (manufactured by Konica Minolta Co., Ltd.). The image fixing rate is a numerical value expressed as a percentage obtained by dividing the reflection density of the solid image after rubbing by the reflection density of the solid image after printing.

Fixing device conditions 1 to 3 described in Table I are as follows.

As the fixing device, three types of fixing devices having the same configuration as in FIG. 2 were used except that the following points were changed.

Fixing device condition 1: In FIG. 2, there is no pressure bonding unit 9, the wavelength of the ultraviolet light irradiated from the irradiation unit 40 is 385 nm (light source: LED light source whose emission wavelength is 385 nm ±10 nm), and the irradiation amount is 500 mW/cm² and the integrated light amount is 5 J/m².

Fixing device condition 2: As illustrated in FIG. 2, the pressure bonding unit 9 is provided, the temperature of the pressure member 91 is 20° C., and the pressure at the time of pressure is 0.2 MPa. The light source and irradiation amount of the irradiation unit 40 are the same as those of the fixing device condition 1.

Fixing device condition 3: As illustrated in FIG. 2, the pressure bonding unit 9 is provided, the temperature of the pressure member 91 is 80° C., and the pressure at the time of pressure is 0.2 MPa. The light source and irradiation amount of the irradiation unit 40 are the same as those of the fixing device condition 1.

The results obtained as described above are indicated n in Table I. Table I

TABLE I

| | | Light phase transition material (A) | | | | | | | | | | | |
|---|---|---|---|---|---|---|---|---|---|---|---|---|---|
| | | | Number | | Binder resin (B) | | | Toner | | | Evaluation result | | |
| Printed | | | average | Melting | | Softening | A:B | particle | | | Fixing | | |
| material | Toner | | molecular | point Tm | | point Tsp | (mass | size | Δ H1 | Δ H2 | device | Fixability | |
| No. | No. | Kind | weight Mn | (° C.) | Kind | (° C.) | ratio) | (μm) | (J/g) | (J/g) | condition | test (%) | Remarks |
| 1 | 1 | Azobenzene | 396 | 87 | 1 | 105 | 40:60 | 7.2 | 32.3 | 23.0 | 1 | 72 | Present |
| | | derivative (1) | | | | | | | | | | | invention |
| 2 | 2 | Azobenzene | 746 | 72 | 2 | 85 | 40:60 | 8.2 | 34.2 | 21.1 | 1 | 75 | Present |
| | | derivative (3) | | | | | | | | | | | invention |
| 3 | 1 | Azobenzene | 396 | 87 | 1 | 105 | 40:60 | 7.2 | 32.3 | 23.0 | 2 | 74 | Present |
| | | derivative (1) | | | | | | | | | | | invention |
| 4 | 1 | Azobenzene | 396 | 87 | 1 | 105 | 40:60 | 7.2 | 32.3 | 23.0 | 3 | 79 | Present |
| | | derivative (1) | | | | | | | | | | | invention |
| 5 | 3 | Azobenzene | 396 | 87 | 3 | 92 | 40:60 | 8.1 | 33.1 | 21.7 | 3 | 81 | Present |
| | | derivative (1) | | | | | | | | | | | invention |
| 6 | 2 | Azobenzene | 746 | 72 | 2 | 85 | 40:60 | 8.2 | 34.2 | 21.1 | 3 | 82 | Present |
| | | derivative (3) | | | | | | | | | | | invention |
| 7 | 4 | Azobenzene | 396 | 87 | 4 | 71 | 20:80 | 8.2 | 11.2 | 5.2 | 3 | 79 | invention |
| | | derivative (1) | | | | | | | | | | | Present |
| 8 | 5 | Azobenzene | 396 | 87 | 4 | 71 | 10:90 | 7.9 | 3.9 | 0.3 | 3 | 81 | invention |
| | | derivative (1) | | | | | | | | | | | Present |
| 9 | 6 | Azobenzene | 802 | 97 | 5 | 112 | 30:70 | 8.9 | 24.5 | 12.1 | 3 | 81 | invention |
| | | derivative (9) | | | | | | | | | | | Present |
| 10 | 7 | Azobenzene | 406 | 52 | 4 | 71 | 10:90 | 7.9 | 3.2 | 0.0 | 3 | 85 | invention |
| | | derivative (13) | | | | | | | | | | | Present |
| 11 | 8 | Azomethine | 285 | 63 | 6 | 80 | 20:80 | 8.3 | 12.1 | 5.1 | 3 | 84 | invention |
| | | derivative (A) | | | | | | | | | | | |
| 12 | 9 | Azobenzene | 396 | 87 | 7 | 125 | 10:90 | 7.5 | 0.0 | 0.0 | 1 | 5 | Comparative |
| | | derivative (1) | | | | | | | | | | | example |
| 13 | 10 | Azobenzene | 406 | 52 | 1 | 105 | 20:80 | 7.8 | 0.0 | 0.0 | 1 | 15 | Comparative |
| | | derivative (13) | | | | | | | | | | | example |

As is clear from the results listed in Table I, the toner of the present invention which includes a light phase transition material and a binder resin, and has an endothermic amount ΔH1 (J/g) based on a melting peak derived from the light phase transition material of 0.1 or more, specifically 3.2 or more. The toner of the present invention is excellent in toner image fixability compared to the comparative example having the endothermic amount ΔH1 (J/g) of 0 and no melting peak.

Although the embodiments of the present invention have been described and illustrated in detail, it is clearly understood that the same is by way of illustration and example only and not limitation, the scope of the present invention should be interpreted by terms of the appended claims

What is claimed is:

1. An electrostatic image developing toner comprising toner particles containing a light phase transition material that change from a solid state to a liquid state by light irradiation and a binder resin,
wherein 4H1 (J/g) satisfies a condition defined by the following relational expression (1), provided that ΔH1 (J/g) is an endothermic amount based on a melting peak derived from the light phase transition material in a first temperature raising process of raising a temperature from 25 to 200° C., the endothermic amount being obtained from a DSC curve measured by differential scanning calorimetry to the electrostatic image developing toner,
0.1≤ΔH1. Relational expression (1):

2. The electrostatic image developing toner described in claim 1,
wherein ΔH1 (J/g) and ΔH2 (J/g) satisfy a condition defined by the following relational expression (2), provided that ΔH2 (J/g) is a second endothermic amount based on a melting peak derived from the light phase transition material in a second temperature rising process of raising a temperature from 25 to 200° C. following the measurement of the first endothermic amount ΔH1 (J/g),
ΔH1<ΔH2. Relational expression (1):

3. The electrostatic image developing toner described in claim 1,
wherein ΔH1 (J/g) and ΔH2 (J/g) satisfy a condition defined by the following relational expression (3),
0≤(ΔH2/ΔH1)×100≤80. Relational expression (2):

4. The electrostatic image developing toner described in claim 1,
wherein the light phase transition material has a number average molecular weight Mn in the range of 150 to 2900.

5. The electrostatic image developing toner described in claim 1,
wherein Tm (° C.) and Tsp (° C.) satisfy a condition defined by the following relational expression (3), provided that Tm (° C.) is a melting point of the light phase transition material, and Tsp (° C.) is a softening point temperature of the binder resin,
Tm≥Tsp −20. Relational expression (4):

6. The electrostatic image developing toner described in claim 1,
wherein the light phase transition material has a melting point Tm in the range of 40 to 120° C.

7. The electrostatic image developing toner described in claim 1,
wherein the binder resin is an amorphous binder resin.

8. An image forming method comprising the steps of:
forming a toner image containing the electrostatic image developing toner described in claim 1 on a recording medium; and
irradiating light to the toner image to soften the toner image.

9. The image forming method described in claim 8,
wherein the irradiated light has a wavelength of 280 nm or more and less than 480 mm.
